(19) United States
(12) Patent Application Publication
(10) Pub. No.: US 2013/0291676 A1
(43) Pub. Date: Nov. 7, 2013

(54) ADJUSTING DEVICE, VEHICLE SEAT AND MOTOR VEHICLE AND METHOD FOR THIS

(71) Applicant: GM GLOBAL TECHNOLOGY OPERATIONS LLC, Detroit, MI (US)

(72) Inventors: Andrzej PLESKOT, Trebur (DE); Arnold PRUEMM, Taunusstein (DE)

(73) Assignee: GM GLOBAL TECHNOLOGY OPERATIONS LLC, Detroit, MI (US)

(21) Appl. No.: 13/797,424

(22) Filed: Mar. 12, 2013

(30) Foreign Application Priority Data
May 7, 2012 (DE) 102012008821.3

(51) Int. Cl. B60N 2/22

(52) U.S. Cl. CPC B60N 2/22
USPC 74/511 R

(57) ABSTRACT

A motor vehicle with a motor vehicle seat is provided. The vehicle seat includes an adjusting device. The adjusting device includes at least two axially spaced detent fittings, at least one transmission unit, which operatively connects the at least two detent fittings in a mounted state, and at least one securing unit for the axial securing of the at least one transmission unit relative to the at least two detent fittings. The at least one securing unit comprises an adapter unit arranged on at least one end of the transmission unit, in order to from a uniform lateral interface. A method for the mounting of a motor vehicle seat is also provided.

### CROSS-REFERENCE TO RELATED APPLICATION

This application claims priority to German Patent Application No. 10 2012 008 821.3, filed May 7, 2012, which is incorporated herein by reference in its entirety.

### TECHNICAL FIELD

The technical field relates to an adjusting device of a seat. The technical field further relates to a vehicle seat. The technical field also relates to a motor vehicle. The technical field relates in addition to a method for mounting an adjusting device.

### BACKGROUND

From the prior art, motor vehicles with seats are known, in which a backrest or a backrest part or respectively the position of the backrest, in particular with respect to a sitting part, is adjustable. The adjustment takes place via an adjusting device arranged at least with two sections or parts on both sides on the seat. The two lateral parts of the adjusting device are operatively connected by means of a transmission unit. The transmission unit is connected, with play, with the two adjusting devices, wherein the play is not able to be set exactly in the conventional mounting methods. Conditional upon mounting, the transmission unit projects at least on one side beyond the adjusting device. Hereby, the adjusting device and hence also the seat are of wider construction. At a laterally projecting part, an operating unit is connected with the transmission unit. Here, the operating units and the transmission units are to be coordinated with one another.

DE 10 2006 0302 39 B3 describes a motor vehicle seat with a backrest, which is mounted via a first adjusting fitting and a second adjusting fitting so as to be adjustable with regard to inclination on both sides on a seat part frame of the motor vehicle seat, wherein the two adjusting fittings are coupled with one another by a single-piece transmission rod, which for the transmission of a torque penetrates through-openings of the adjusting fittings in a form-fitting manner and serves for the simultaneous adjustment of both adjusting fittings by means of a drive device associated with the first adjusting fitting. The motor vehicle seat is distinguished in that the through-opening of the second adjusting fitting has a ribbing, which though an axial force acting on the transmission rod during mounting presses therein in a torque-proof manner. The transmission rod projects here beyond the adjusting fittings. Furthermore, the firm fit of the transmission rod is achieved at least by means of a force fit, so that the transmission rod is not mounted with play. The mounting of the transmission rod is also time-consuming and requires additional working steps.

In addition, other objects, desirable features and characteristics will become apparent from the subsequent summary and detailed description, and the appended claims, taken in conjunction with the accompanying drawings and this background.

### SUMMARY

Accordingly, the present disclosure provides an improved adjusting device for a vehicle seat, which ensures a simple mounting of the transmission unit and its operating unit. In particular, the present disclosure provides a motor vehicle, a vehicle seat and a method for this.

The present disclosure includes the technical teaching that in an adjusting device of a seat, for example, of a motor vehicle seat, comprising at least two axially spaced detent fittings, at least one transmission unit is provided, which operatively connects the at least two detent fittings in a mounted state, and at least one securing unit is provided for the axial securing of the at least one transmission unit relative to the at least two detent fittings, that the at least one securing unit comprises an adapter unit arranged on at least one end of the transmission unit, in order to form a uniform, lateral interface.

Such an adjusting device is, on the one hand, able to be mounted in a simple manner, in particular tool-free and without additional parts. On the other hand, an exact setting of the play is possible here of the at least one transmission unit which is arranged between the at least two detent fittings. In addition, a uniform interface is ensured for different operating units. The adjusting device serves for the folding or respectively adjusting of a backrest part relative to a sitting part of the seat. In one exemplary embodiment, the adjusting device has precisely two detent fittings. These two detent fittings are generally arranged respectively on two opposite sides of the seat. The detent fittings are spaced apart from one another here in axial direction. Furthermore, the two detent fittings in the mounted state of the adjusting device are operatively connected by means of at least one transmission unit, in order to ensure a reliable adjusting of the backrest part. The at least one transmission unit is arranged axially on or respectively between, i.e. within an axial distance of the detent fittings and projects by at least one end for the mounting of the operating unit laterally out over the corresponding detent fitting. Within the scope of this patent application, the location “axial” or respectively “axial direction”, in so far as not indicated otherwise, refers to an axial extent of the at least one transmission unit. The transmission unit forms a rotation axis or detent fitting rotation axis, about which the backrest part is rotatable. By a rotating of the transmission unit, the detent fittings and hence the adjusting device are released or respectively locked.

One exemplary embodiment provides precisely one transmission unit. The transmission unit has two opposite end sections, which in a mounted state are generally connected with the detent fittings in a secure manner with regard to rotation, more precisely with a part which is rotatable with respect to the other part of the detent fitting unit. A middle section is formed between the end sections. The transmission unit is constructed in one part or in several parts. For example, the transmission unit is constructed at least partially in a cylinder shape and/or at least in the region of the end section in a profiled or angular shape, i.e. is constructed rotationally asymmetrically. In an embodiment, the transmission unit is constructed as a cylindrical rod with square-profile-like end sections. In other embodiments, the end sections, which project over the respective detent fitting, are constructed with other profiles.

For the operative connection of the detent fittings or respectively for the secure connection of the transmission unit with the detent fittings, the transmission unit is arranged, generally at its end sections, so as to be secure with regard to rotation in the detent fittings. For this, the detent fittings have for example receiving spaces and/or bearing regions complementary to the end sections, in which the end sections of the transmission unit are mounted in the mounted state. For simplified mounting, a receiving space is advantageously constructed as a passage region, so that the transmission unit is able to be guided at least partially through this passage region. The transmission unit is generally arranged in axial direction with play between, or respectively within, the detent fittings.

Furthermore, the adjusting device comprises at least one securing unit. The at least one securing unit serves for the axial securing of the transmission unit relative to the detent fittings. Here, the transmission unit is secured in axial direction, wherein at least one end section or respectively its front side is arranged outside, i.e. not between or respectively within, the detent fittings. The at least one securing unit is generally constructed so as to be integrated into the adjusting device. In one exemplary embodiment, precisely one securing unit is constructed. Other embodiments provide more than one, for example two, three or four securing units. The securing unit is constructed in one part or in several parts. Generally, the securing unit acts in at least one axial direction of the transmission unit. In one example, the securing unit acts in both axial directions of the transmission unit. In particular, the securing unit prevents or respectively delimits a movement or respectively a play of the transmission unit in axial direction, abbreviated to axial play or only play.

According to the present disclosure, the securing unit has an adapter unit arranged on at least one end of the transmission unit, in order to form a uniform lateral interface.

In an exemplary embodiment, provision is made that the adapter unit is arranged on at least one end of the transmission unit projecting out over the detent fitting. Generally, the adapter unit is arranged at one end of the transmission unit. In another embodiment, the adapter unit is arranged at both ends. The end of the transmission unit is generally constructed as an end section, in particular as a rotationally asymmetrical end section.

In an exemplary embodiment of the adjusting device, provision is made that the adapter unit has an engagement part on a side facing the detent fitting. The adapter unit is able to be secured in axial direction with this engagement part.

Accordingly, in another exemplary embodiment provision is made that the securing unit has at least one engagement section corresponding to the engagement part. The engagement part cooperates with the engagement section in the mounted or ready-for-use state, so that the adapter unit is secured in axial direction relative to the securing unit. The engagement part and the engagement section are embodied for example as a clip connection, as an undercut connection and/or as an arbitrary connection securing in axial direction. Thus, in addition, a radial securing is realized. Accordingly, the adapter unit is connected on the one hand with the transmission unit and on the other hand with the securing unit.

Another exemplary embodiment makes provision that the engagement section is constructed on at least one bearing site of the corresponding detent fitting or respectively of the detent fittings for the bearing of the transmission unit. The bearing site is constructed for example with a bearing. In an embodiment, the bearing is constructed as a bush or suchlike. The bush or respectively the bearing has here a lateral stop surface constructed as a flange, which projects radially such that the bearing is not movable through the corresponding bearing opening of the detent fitting. In an embodiment, the stop surface is embodied spaced apart from the detent fitting, so that a free space remains between flange and detent fitting. The free space which is thus formed generally forms the engagement section. A groove-like depression or a type of undercut is formed through the flange and the detent fitting, into which a corresponding engagement part engages. Accordingly, the engagement part or the engagement part of the adapter unit is constructed with a corresponding projection, which engages into the engagement section. For this, the projection is generally constructed so as to be deformable elastically, so that a type of clip connection is able to be formed. In an embodiment, the bearing site is constructed so as to be integrated into the detent fitting. In another embodiment, the bearing site is constructed in the securing unit. In another exemplary embodiment, the bearing site is constructed both in the detent fitting and also in the securing unit. In an embodiment, the securing unit is constructed so as to be integrated in the detent fitting.

In an exemplary embodiment, provision is made that the adapter unit has a transmission mount to receive an end of the transmission unit. So that the adapter unit is secured on the transmission unit, a corresponding mount is provided. Generally, the mount is constructed as an opening, through-opening or blind hole. So that an arrangement of the adapter unit on the transmission unit is ensured which is secure with regard to rotation, the mount and the corresponding end section of the transmission unit are constructed so as to be rotationally asymmetrical, more precisely in a complementary manner rotationally asymmetrical and/or with a corresponding profile. Generally, the connection of the adapter unit and of the received end section is formed in a force-fitting, materially bonded and/or form-fitting manner. For example, the connection is formed as a press fit. In another embodiment, the connection is formed as a materially bonded connection, for example by means of gluing, welding, soldering or suchlike. Another exemplary embodiment provides for a screwing, riveting or suchlike.

In addition, an exemplary embodiment makes provision that the adapter unit has an operating mount for an operating unit of the adjusting device. Therefore, the adapter unit forms a uniform interface for the operating unit. The adapter unit is provided in order to connect differently formed operating units with differently formed operating units. This is constructed for example so as to be integrated into the transmission unit and/or the operating unit. The adapter unit is constructed accordingly in one piece or in several pieces. The adapter unit is generally constructed in one piece. In the case of various manufacturers of transmission units and/or operating units, the adapter unit is sent to the manufacturers, who can then connect it respectively with the transmission unit and/or with the operating unit.

In addition, provision is made in an exemplary embodiment that the operating mount has an engagement section. In another exemplary embodiment, provision is made that the operating unit has an engagement section for cooperating with the operating mount. Similarly to with the connection of the adapter unit with the transmission unit or respectively the securing unit, a connection of the adapter unit with the operating unit is also necessary. In order to realize a suitable connection, the operating unit and/or the operating mount has an engagement section which are constructed for cooperation. The engagement sections correspond to one another here. The operating mount or respectively the engagement section of the operating mount is constructed, for example, as a groove, undercut or suchlike. The engagement section of the operating unit is constructed, for example, as a projection, nose or suchlike, which engages into the groove or the undercut. In this way, a clip connection of the operating unit with the adapter unit is able to be realized, so that the two units are able to be connected in a tool-free manner. In other exemplary embodiments, other connections are provided, for example any type of form-fitting, force-fitting and/or materially bonded connections.

The present disclosure further provides that in a vehicle seat with a backrest part able to be adjusted with respect to a sitting part, comprising at least one adjusting mechanism for adjusting the backrest part, provision is made that the adjusting mechanism is constructed as the adjusting device described above. The vehicle seat advantageously comprises on the backrest part and the sitting part respectively a seat cushion and a seat cover. In an embodiment, the vehicle seat comprises a facing in the region of the seat part and/or of the backrest part. Advantageously in a vehicle seat with the adjusting device described above, the components of a conventional vehicle seat are able to be used. Several vehicle seats can be advantageously arranged in a space-saving manner adjacent to one another.

The present disclosure also provides that in a motor vehicle comprising at least one seat arrangement, provision is made that the seat arrangement is constructed as the vehicle seat described above. The motor vehicle is constructed for example as a limousine, station wagon, coupe, sport-utility vehicle, (mini) bus or suchlike. Advantageously, the motor vehicle comprises several seat arrangements, described above, with an arrangement according to the present disclosure of the transmission units, for example as a driver's, passenger's and/or rear (bench) seat.

In addition, the present disclosure provides a method for the mounting of an adjusting device of a seat, in particular of a vehicle seat, with at least two detent fittings, so that the at least two detent fittings are operatively connected with the transmission unit, at least comprising introducing the at least one transmission unit in axial direction into a respective passage region of the respective detent fitting and installing of an operating unit on the transmission unit, provision is made that an adapter unit is mounted between the transmission unit and the operating unit, so that the operating unit is connected with the transmission unit via the adapter unit. In this way, different transmission units with different operating units can be realized in a simple manner via the adapter unit, functioning as a uniform interface.

An exemplary embodiment makes provision that the adapter unit is pre-mounted with the transmission unit. A another exemplary embodiment makes provision that the operating unit is mounted onto the adapter unit in a tool-free manner.

On mounting, the transmission unit is advantageously guided through a first detent fitting from the direction of a side facing away from a second detent fitting to the second detent fitting. In an embodiment, a recoil- or respectively spring element is provided. The recoil- or respectively spring element in a passage region of the first detent fitting is pressed here by pressure from the passage region and thus frees the introduction or respectively movement of the transmission unit in this direction. Generally, a guiding in or respectively through of the transmission unit takes place until a first or respectively front end section in the other, axially spaced detent fitting is reached and is mounted there, in particular is mounted so as to be secure with respect to rotation. As soon as the transmission unit or respectively a second or respectively rear end section of the transmission unit leaves the passage section or respectively no longer presses the recoil element away, the recoil element strikes or respectively springs back into its initial position and now acts as a stop, so that a movement of the transmission unit in the opposite direction is prevented.

The play or respectively the movement of the transmission unit is now delimited on one side by the stop unit, constructed as recoil element. On another side, the movement is advantageously delimited by a second stop unit, which is generally integrated into the detent fitting on this side. A stop unit is constructed for example by the adapter unit.

In an exemplary embodiment, the adapter unit is pre-mounted, either on the transmission unit and/or on the operating unit. Generally, the adapter unit is pre-mounted on the transmission unit. Then the transmission unit is connected with the detent fittings. For this, the transmission unit is guided through the corresponding bearing sites. The adapter unit is clipped or otherwise connected here with at least one bush of the bearing site. Then, the operating unit is connected with the adapter unit. The operating unit is placed here on the front side onto the adapter unit and is connected therewith generally in a tool-free manner, for example via a clip connection.

The securing of the transmission unit or respectively its movement takes place generally automatically without additional effort. Accordingly, the mounting method according to the present disclosure is carried out in a tool-free manner This is enabled in particular in that no additional components are necessary. For example, the introducing of the transmission unit is able to be carried out manually. Hereby, the mounting is greatly simplified, in particular with regard to an expenditure of cost and effort. Furthermore, the play of the transmission unit is generally adjustable.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is diagrammatically in a perspective view a cutout of a motor vehicle seat with an adjusting device;

FIG. 2 is diagrammatically in a perspective view an enlarged cutout of the adjusting device according to FIG. 1;

FIG. 3 is diagrammatically in a perspective view a further enlargement of the adjusting device according to FIGS. 1 and 2;

FIG. 4 is diagrammatically a contour or respectively a cross-section of an end section of a transmission unit of the adjusting device;

FIG. 5 is diagrammatically another exemplary embodiment of the end section of the transmission unit;

FIG. 6 is diagrammatically a contour or respectively a cross-section of the end section according to FIG. 5;

FIG. 7 is diagrammatically an adapter unit in a side view and a top view;

FIG. 8 is diagrammatically an operating unit in a perspective view;

FIG. 9 is diagrammatically in a cross-sectional view a connection of the operating unit via the adapter unit with the transmission unit;

FIG. 10 is diagrammatically in a cross-sectional view a connection of the adapter unit with the transmission unit;

FIG. 11 is diagrammatically in a cross-sectional view a cutout of the adjusting device with two detent fitting units and bearing sites without transmission unit;

FIG. 12 is diagrammatically the cutout according to FIG. 11 in a further mounting position, in which the adapter unit is mounted with the transmission unit according to FIG. 10;

FIG. 13 is diagrammatically the cutout according to FIG. 12 with an operating unit before its being mounted; and

FIG. 14 is diagrammatically the cutout according to FIG. 13 with the mounted operating unit.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

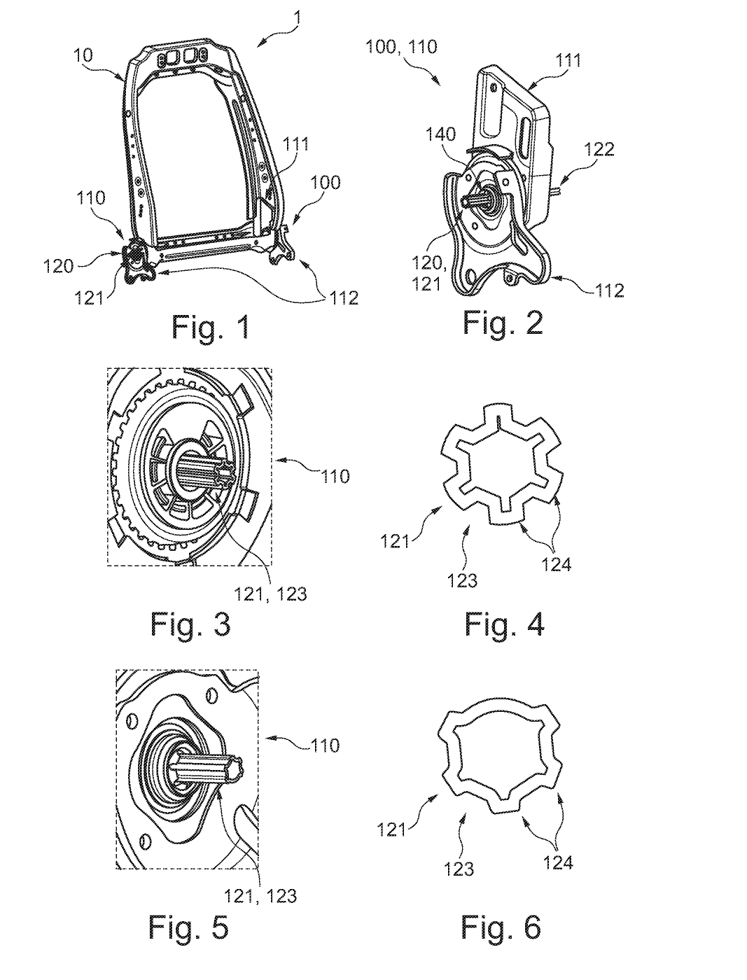

FIGS. 1 to 14 show in various views and degrees of detailing, a motor vehicle seat 1 with an adjusting device 100. The motor vehicle seat 1 comprises a backrest part 10 and a sitting part (not illustrated here). These are connected with one another so as to be foldable with respect to one another via the adjusting device 100. For this, the adjusting device 100 has two detent fittings 110 spaced apart from one another laterally. The detent fittings 110 have a part 112 on the sitting side, and a part 111 on the backrest side, with which the detent fittings 110 are arranged accordingly on the backrest part 10 or respectively on the sitting part. The part 111 on the backrest side is in engagement with the part 112 on the sitting side. The engagement is able to be locked or released by actuating a transmission unit 120 connecting the detent fittings 110. Accordingly, the transmission unit 120 is connected in a torque-proof manner with the corresponding part of the detent fittings 110. For actuating or operating the transmission unit 120, the transmission unit 120 is connected in a torque-proof manner with an operating unit 130. The more precise structure of the adjusting device 100 and a method for mounting the adjusting device 100 or respectively the motor vehicle seat 1 is described in more detail with the aid of the following figures. For identical or similar components, identical reference numbers are used. A detailed description of components which have already been described is dispensed with for reasons of clarity.

FIG. 1 shows diagrammatically in a perspective view a cutout of a motor vehicle seat 1 with an adjusting device 100. The motor vehicle seat 1 comprises the backrest part 10 and a sitting part, which is not illustrated here, with respect to which the backrest part 10 is able to be folded. The supporting structure of the backrest part 10 is illustrated. This means that the upholstery is not illustrated here. The adjusting device 100 has the two detent fittings 110 spaced apart from one another laterally. The detent fittings 100 are coupled with one another via the transmission unit 120, wherein the transmission unit 120 forms a rotation axis about which the backrest part 10 is able to be folded relative to the sitting part. The detent fittings 110 have the part 111 on the backrest side and the part 112 on the sitting side. The part 111 on the backrest side is securely connected with the backrest part 10. The part 112 on the sitting side is securely connected with the sitting part. The two parts 111, 112 are in engagement with one another. The engagement is able to be released or locked via the transmission unit 120. As illustrated in FIG. 1, the transmission unit 120 projects laterally over the corresponding detent fitting 110 by an end or respectively end section 121. The transmission unit 120 is able to be operated with a corresponding operating unit 130 (see FIG. 8) via this end section 121.

FIG. 2 shows diagrammatically in a perspective view an enlarged cutout of the adjusting device 100, more precisely of a detent fitting 110, according to FIG. 1. The two parts 111, 112 in engagement with one another can be clearly seen. The transmission unit 120 is constructed as a profiled axis or respectively shaft with two end sections 121 (here only one end section 121 is illustrated) and with a middle section 122. The middle section 122 is constructed here rotationally symmetrically. The end section 121 is constructed rotationally asymmetrically as a profiled end section 121. Two example end sections 121 are illustrated in FIGS. 3 to 6. In order to secure the transmission unit 120 in axial direction, a securing unit 140 is provided. This is described in more detail in FIGS. 11 to 14.

FIG. 3 shows diagrammatically in a perspective view a further enlargement of the adjusting device 100 according to FIGS. 1 and 2. A first embodiment of an end section 121 is illustrated here. The transmission unit 120 or respectively the end section 121 is constructed as a hollow shaft 123. The end section 121, projecting over the detent fitting 110, is constructed here with a profile in the manner of a toothed wheel. The latter is illustrated in more detail in FIG. 4.

FIG. 4 shows diagrammatically a contour or respectively a cross-section of an end section 121 of the transmission unit 120 of the adjusting device 100. As can be readily seen, the end section 121 is constructed as a hollow shaft 123 or respectively as a hollow shaft section. The end section 121 has a profile here in the form of a toothed wheel. The teeth 124 of the profile in the form of a toothed wheel are constructed so as to be approximately rectangular. In this way, a rotationally asymmetrical outer contour of the end section 121 is constructed for torque-proof connection.

FIG. 5 shows diagrammatically another exemplary embodiment of the end section 121 of the transmission unit 120 of the adjusting device 100. Here, an exemplary embodiment of the end section 121 is illustrated. The transmission unit 120 or respectively the end section 121 is constructed as a hollow shaft 123. The end section 121 projecting over the detent fitting 110 is constructed here with a profile in the manner of a toothed wheel. The latter is illustrated in more detail in FIG. 6.

FIG. 6 shows diagrammatically a contour or respectively a cross-section of the end section 121 according to FIG. 5. Here, also, the end section 121 is constructed as a hollow shaft 123 or respectively as a hollow shaft section. The end section 121 also has a profile in the form of a toothed wheel here for a torque-proof connection. The teeth 124 of the profile in the form of a toothed wheel are constructed approximately in a rectangular shape. In this way, a rotationally asymmetrical outer contour of the end section 121 is constructed for torque-proof connection.

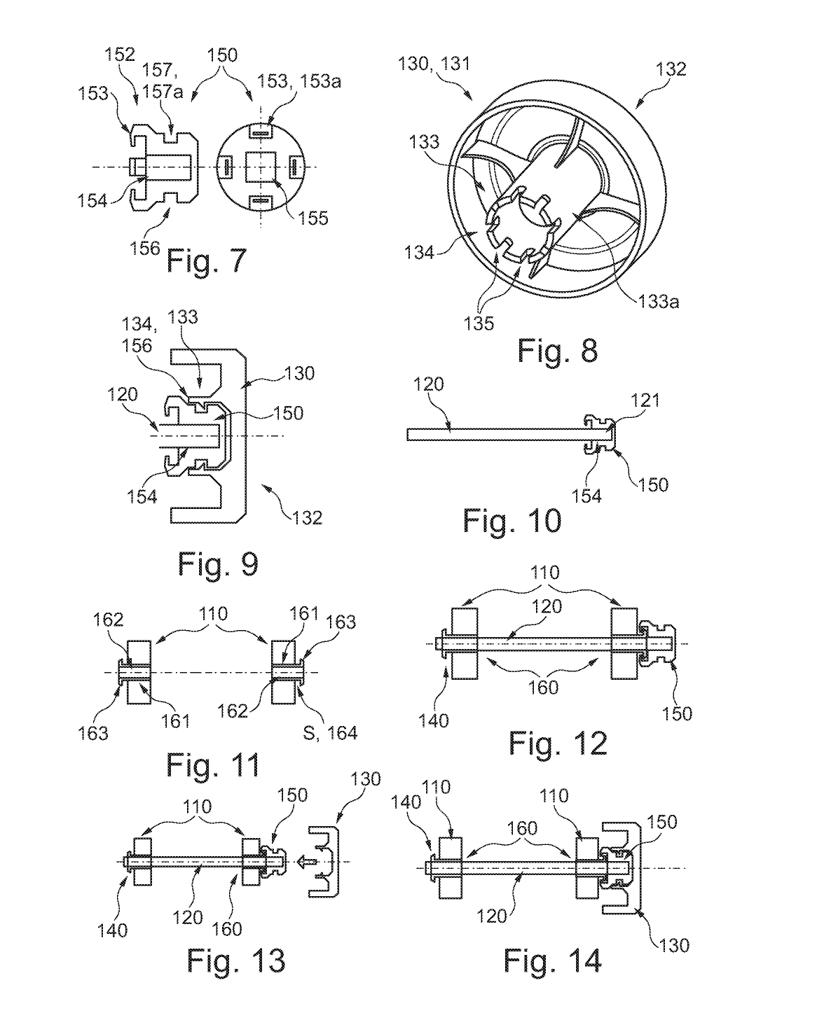

FIG. 7 shows diagrammatically an adapter unit 150 in a side view and a top view. The adapter unit 150 is constructed for connection to the security unit 140, the transmission unit 120 and the operating unit. For this, the adapter unit 150, constructed in one piece, has an engagement part 152, a transmission mount 154 and an operating mount 156. The engagement part 152 is constructed for cooperating with the securing unit 140, more precisely with a corresponding engagement section of the securing unit 140. The engagement part 152 is constructed in the manner of a claw with four projections 153 spaced uniformly apart from one another peripherally. The projections 153 function as claws 153a and are constructed accordingly so as to be deformable elastically, in order to engage into the corresponding engagement section of the securing unit 140. In this way, a clip connection is able to be realized with the projections 153. The transmission mount 154 is constructed as a rotationally asymmetrical blind hole 155. The blind hole 155 has a square profile here, which is shaped to an end section 121 of the transmission unit 120 constructed accordingly in a complementary manner. According to the end section 121, other profiles are also able to be selected for the blind hole 155. The corresponding end section 121 is received in a torque-proof manner or so as to be secure with regard to rotation in the transmission mount 154. An additional securing by means of a corresponding connection is provided. The operating mount 156 has a corresponding engagement section 157, which is constructed here as a circumferential groove 157a. A corresponding or complementary engagement section 134 of the operating unit 130 is able to be received in the groove 157a. The operating unit 130 for mounting is illustrated in FIG. 8.

FIG. 8 shows the operating unit 130 diagrammatically in a perspective view. The operating unit 130 is constructed as a hand wheel 131 with an outer part 132 and an inner part 133. The outer part 132 is constructed ergonomically for an operator. Here, the outer part 132 is constructed as a rotary knob. The inner part 133 has a sleeve-like part 133a. This sleeve-like part 133a has the engagement section 134. The engagement section 134 is formed by elastically deformable projections or noses 135, which engage into the corresponding operating mount 156 of the adapter unit 150. The cooperating of the operating unit 130 and the adapter unit 150 is illustrated in FIG. 9.

FIG. 9 shows diagrammatically in a cross-sectional view a connection of the operating unit 130 via the adapter unit 150 with the transmission unit 120. The transmission unit 120, constructed as a shaft, is received in the transmission mount 154, in the manner of a blind hole, of the adapter part 150. There, the transmission unit 120 is connected in a torque-proof manner and also axially secured with the adapter part 150. The connection is embodied here as a press fit. The operating unit 130 is connected with the adapter part 150 via the engagement section 134. For this, the engagement section 134 engages into the groove-shaped operating mount 156. The sleeve-like part 133a is moved over an outer surface of the adapter unit 150, so that the adapter unit 150 is partially surrounded by the sleeve-like part 133a. The engagement section 134 is constructed so as to be elastically resilient, so that a clip connection between operating unit 130 and adapter unit 150 is realized. The adapter unit 150 is illustrated by way of example as in FIG. 10 with the transmission unit 120, pre-mounted.

FIG. 10 shows diagrammatically in a cross-sectional view a connection of the adapter unit 150 with the transmission unit 120. Here, the transmission unit 120, embodied as a shaft or axis, is received with its end section 121 in a torque-proof manner and axially secured in the transmission mount 154 of the adapter unit 150. The connection of the transmission unit 120 with the adapter unit 150 is embodied here as a press fit. In order to mount the adjusting device 100, the adapter unit 150 is pre-mounted with the operating unit 120, as illustrated in FIG. 10. The thus pre-mounted arrangement is then mounted with the detent fittings 110. The detent fittings 110 have corresponding bearing sites and securing unit 140, as illustrated in FIG. 11.

FIG. 11 shows diagrammatically in a cross-sectional view a cutout of the adjusting device 100 with two detent fitting units or detent fittings 110 and bearing sites 160 without transmission unit 120. The two detent fittings 110 are spaced apart from one another axially. To receive the transmission unit 120, a bearing site 160 is constructed per detent fitting 110. The respective bearing site 160 is constructed by a through-opening 161 in the respective detent fitting 110 and a corresponding bearing bush 162. The bearing bush 162 is constructed complementary to the through-opening 161 and is fitted into the latter. The respective bearing bush 162 has here on the end side a stop surface which is constructed by a flange 163. The bearing bush 162 is constructed here so that a gap S remains between the detent fitting 110 and the flange 163 and thus an engagement section 164 is formed. The engagement section 164 is generally formed on both outwardly-directed sides of the detent fitting. The engagement section 164 is constructed so that the engagement part 152 of the adapter unit 150 can engage into this. Accordingly, through the bearing bush 162 the security unit 140 is realized, which is thereby constructed so as to be integrated at least partially into the detent fitting 110. The security unit 140 which is thus constructed from the detent fitting 110 and the bearing bush 162 prevents or reduces an axial movement of the adapter unit 150. The connection of the arrangement according to FIG. 10 with the arrangement according to FIG. 11 is illustrated in FIG. 12.

FIG. 12 shows diagrammatically the cutout according to FIG. 11 in a further mounting position, in which the adapter unit 150 is mounted with the transmission unit 120 according to FIG. 10. The transmission unit 120 is pre-mounted with the adapter unit 150. This is now guided into the bearing sites 160 of the detent fittings, so that the end sections 121 of the transmission unit 120 project laterally outwards over the detent fittings 110 or respectively the bearing sites 160. The adapter unit 150 with the engagement part 152 is brought here into operative connection with the engagement section 164 of the security unit 140. For this, the claw-like projections 153 deform elastically and engage into the gap S, wherein the projections 153 return into their initial state. In this way, an undercut-like connection of the adapter unit 150 with the securing unit 140 is realized. The gap S is dimensioned here so that the engagement of the engagement part 152 with the engagement section 164 has a little play, in order to rotatably mount the transmission unit 120. The further mounting steps are illustrated in FIGS. 13 and 14.

FIG. 13 shows diagrammatically the cutout according to FIG. 12 with the operating unit 130 before its being mounted, and FIG. 14 shows diagrammatically the cutout according to FIG. 13 with the mounted operating unit 130. As soon as the adapter unit 150 is connected accordingly on the transmission unit 120 with the detent fittings 110, the operating unit 130 is connected with the adapter unit 150. For this, the operating unit 130 is pushed onto the adapter unit 150, until its engagement section 134 engages into the operating mount 156, as previously described in FIG. 9. The arrangement of transmission unit 120, adapter unit 150 and operating unit 130 is secured via the security unit 140 against an axial detaching from the detent fittings 110.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An adjusting device of a vehicle seat, comprising:
at least two axially spaced detent fittings;
at least one transmission unit, which operatively connects the at least two detent fittings in a mounted state; and
at least one securing unit for the axial securing of the at least one transmission unit relative to the at least two detent fittings,
wherein the at least one securing unit includes an adapter unit arranged on at least one end of the transmission unit, in order to form a uniform, lateral interface.

2. The adjusting device according to claim 1, wherein the adapter unit is arranged on an end of the transmission unit projecting over one of the at least two detent fittings.

3. The adjusting device according to claim 2, wherein the adapter unit has an engagement part on a side facing the one of the at least two detent fitting.

4. The adjusting device according to claim 3, wherein the securing unit has at least one engagement section corresponding to the engagement part.

5. The adjusting device according to claim 4, wherein the at least one engagement section is constructed on at least one bearing site of the detent fitting for bearing the transmission unit.

6. The adjusting device according to claim 5, wherein the adapter unit has a transmission mount to receive an end of the transmission unit.

7. The adjusting device according to claim 6, wherein the adapter unit has an operating mount for an operating unit of the adjusting device.

8. The adjusting device according to claim 7, wherein the operating mount has an engagement section.

9. The adjusting device according to claim 7, wherein an operating unit is provided, which has an engagement section for cooperating with the operating mount.

10. A vehicle seat with a backrest part which is adjustable with respect to a sitting part, comprising:
at least one adjusting mechanism for adjusting the backrest part including at least two axially spaced detent fittings, at least one transmission unit, which operatively connects the at least two detent fittings in a mounted state, at least one securing unit for the axial securing of the at least one transmission unit relative to the at least two detent fittings,
wherein the at least one securing unit includes an adapter unit arranged on at least one end of the transmission unit so as to project over one of the detent fittings, in order to form a uniform, lateral interface.

11. The vehicle seat according to claim 10, wherein the adapter unit has an engagement part on a side facing the one of the at least two detent fitting.

12. The vehicle seat according to claim 11, wherein the securing unit has at least one engagement section corresponding to the engagement part.

13. The vehicle seat according to claim 12, wherein the securing unit has at least one engagement section corresponding to the engagement part.

14. The vehicle seat according to claim 13, wherein the at least one engagement section is constructed on at least one bearing site of the detent fitting for bearing the transmission unit.

15. The vehicle seat according to claim 14, wherein the adapter unit has a transmission mount to receive an end of the transmission unit.

16. A motor vehicle, comprising:
at least one seat arrangement having a vehicle seat with a backrest part; and
at least one adjusting mechanism for adjusting the backrest part including at least two axially spaced detent fittings, at least one transmission unit, which operatively connects the at least two detent fittings in a mounted state, at least one securing unit for the axial securing of the at least one transmission unit relative to the at least two detent fittings,
wherein the at least one securing unit includes an adapter unit arranged on at least one end of the transmission unit, in order to form a uniform, lateral interface and the adapter unit has an engagement part on a side facing the detent fitting.

17. A method for mounting an adjusting device of a vehicle seat, with at least two detent fittings, so that the at least two detent fittings are operatively connected with the transmission unit, comprising:
introducing the at least one transmission unit into a respective bearing site of the respective detent fitting and arranging an operating unit on the transmission unit,
wherein an adapter unit is mounted between transmission unit and operating unit, so that the operating unit is connected with the transmission unit via the adapter unit.

18. The method according to claim 17, wherein the adapter unit is pre-mounted with the transmission unit.

19. The method according to claim 18, wherein the operating unit is mounted in a tool-free manner onto the adapter unit.
